(19) United States
(12) Patent Application Publication
(10) Pub. No.: US 2005/0015322 A1
(43) Pub. Date: Jan. 20, 2005

(54) Order system

(76) Inventor: Paul G. Seils, Queensland (AU)

Correspondence Address: Martin P Hoffman;Hoffman Wasson & Gitler, Suite 522, 2361 Jefferson Davis Highway, Arlington, VA, 22202-3876, US

(21) Appl. No.: 10/495,760

(22) PCT Filed: Oct. 3, 2002
(86) PCT No.: PCT/AU02/01349

(30) Foreign Application Priority Data
Oct. 3, 2001 (AU) PR 8070

(51) Int. Cl. G06F 17/60

(52) U.S. Cl. 705/37

(57) ABSTRACT

A method of trading comprising the steps of a trader establishing a mechanism by which the traders product or service can be ordered by an orderer, delivering product or services in response to an order, taking an image of the product or service delivery and the person receiving the order, and transmitting a copy of the image to the orderer by way of confirmation of delivery.

### TECHNICAL FIELD

The present invention relates to methods of trading utilising a digital receipt verification system and in particular provides a method of trading in which the a digital receipt verification system is used by a trader selling goods or services and is used to confirm delivery of those goods or services.

### BACKGROUND ART

The world wide computing network or Internet has provided a means of the speedy transmission of messages and images at a relatively low cost.

The Internet has changed much in the two decades since it came into existence. It was conceived in the era of time-sharing, but has survived into the era of personal computers, client-server and peer-to-peer computing, and the network computer. It was designed before Local Area Networks existed, but has accommodated that new network technology, as well as the more recent ATM and frame switched services. It was envisioned as supporting a range of functions from file sharing and remote login to resource sharing and collaboration, and has spawned electronic mail and more recently the World Wide Web. But most important, it started as the creation of a small band of dedicated researchers, and has grown to be a commercial success with billions of dollars of annual investment.

The Internet has not yet finished changing. The Internet, although a network in name and geography, is a creature of the computer, not the traditional network of the telephone or television industry. It will continue to change and evolve at the speed of the computer industry. It is now changing to provide such new services as real time transport, in order to support, for example, audio and video streams. The availability of pervasive networking (i.e., the Internet) along with powerful affordable computing and communications in portable form (i.e., laptop computers, two-way pagers, PDAs, cellular phones), is making possible a new paradigm of nomadic computing and communications.

This evolution will bring new applications—Internet telephone and, slightly further out, Internet television. It is evolving to permit more sophisticated forms of pricing and cost recovery. It is changing to accommodate yet another generation of underlying network technologies with different characteristics and requirements, from broadband residential access to satellites. New modes of access and new forms of service will spawn new applications, which in turn will drive further evolution of the net itself.

Digital cameras are now becoming popular as a means of taking photographs. Digital cameras are quite well known and are capable of taking a still photograph or movie footage and storing the images and sound in electronic and transferable form.

Also known are the latest type of digital camera combined with a mobile telephone in a single unit. One such unit is made by Siemens and is a combination of personal organiser and mobile phone for mobile business communication. Based on Microsoft's Pocket PC operating system, the unit with an integrated GSM phone is changing the standard of mobile voice and data based communication. The unit brings integration of personal organiser and mobile phone functionality allowing the sending and receiving of e.g. emails or short message service in one compact device.

The unit also enables the downloading and storage of software applications directly from a server opening the door to thousands of applications which can be installed and run on the onboard memory.

Using the stereo headset users have access to full phone functionality via the integrated phone book manager using a touchscreen display. With a backlit TFT colour screen, capable of displaying over 65,000 colors the unit has an adaptable and useful display. This clarity ensures that applications such as electronic books, still image viewing and gaming can be viewed with clarity.

The GSM capability of the unit means practical mobile access to the Internet, either through the device's wireless application protocol (WAP) Browser or via the HTTP Browser supplied with software packages. In addition to accessing WAP and Internet sites, the unit can be configured to provide remote access to corporate local area networks or Intranets via the HTTP Browser.

The photographs and recovered images can be transmitted via a computer.

Currently, when a delivery is made to a person or company, the receiver is required to sign a form of some description to acknowledge that the delivery has been confirmed. The sender may be informed of the delivery but generally is not informed. With some newer or more progressive delivery companies, it is possible for a sender to check on whether or not a delivery has been made by logging on to a website and checking their receipt number for confirmation. This type of confirmation is generally a checkbox that is completed by administrative staff upon the return of the delivery staff member that delivered the article.

The delivery may be made pursuant to an order placed by telephone, on-line on the Internet or other world wide computer network, or even by posting an order form.

In general when a person purchases a gift for another, the issue of its timely delivery to the recipient is something which would only be confirmed by a subsequent contact by the sender with the receiver.

It is an object of the present invention to provide a method of trading using Internet facilities where the delivery of goods or services is confirmed by using inter alia, a photographic image.

Further objects and advantages of the present invention will become apparent from the ensuing description which is given by way of example.

### DISCLOSURE OF INVENTION

According to a broad form of the present invention there is provided a method of trading comprising the steps of;
(a) a trader establishing a mechanism by which the traders product or service can be ordered,
(b) delivering product or services in response to an order,
(c) taking an image of the product or service delivery and the person receiving the order, and
(d) transmitting a copy of the image to the orderer by way of confirmation of delivery.

An example of the method of the present invention may be as follows. A person or company orders any product or service from a trader. The trader may be located in any region or country in the world and the sender of the goods or services may be in another region or country. Generally the sender may order the goods from a business that provides the goods or services in the intended destination.

The order can be transmitted from the sender to the trader in any way. Examples of such order mechanisms may be by telephone, in person, by postal order or over the Internet. The Internet provides added functionality when ordering as it is generally the fastest way and allows the utilisation of a number of different forms of instantaneous payment as well.

When the order is delivered to the intender recipient of the goods or services, a digital image of the delivery and/or the recipient is captured using a digital recording device. The preferred form of digital recording device may be a digital camera capable of capturing still or movie images. The digital recording device may also be capable of capturing sound.

This data may then be stored on computer disc for later copying onto a computer network or transmitted immediately if capabilities allow this. Generally the data will be returned to the trader for loading onto a computer network. In cases where the transmission of the data is not instantaneous, a short message service message (SMS) or electronic mail message may be sent to the orderer to confirm delivery/receipt of the order.

Once the data has been returned to the trader, the trader may load the data onto the Internet or other national or international computer network at a specific site. This site may be accessible by the orderer upon entry of a password provided to the orderer upon payment or placing the order.

The orderer can then visit the specific site, enter the password provided and view the data in the form of a still image or movie of the delivery. The benefits of this method may be commercial or personal in nature. Examples of commercial benefits are that the trader may have agreements in place to show advertising promoting the trader and/or the manufacturer of the goods or services on the specific site. This may add value. The images or still images from a movie may be able to be printed out at a cost to the viewer. This may allow increased spending by the viewer. The method also allows confirmation of delivery which may improve quality control, reduce costs and reduce problems for the trader.

An example of benefits for the users of the method is that it allows the users to be certain that the delivery was made and also allow the orderer to view the reaction of the recipient of the ordered goods or services. This may be especially useful in the case of gift giving.

The trader may be the same as the deliverer of the goods or services or they may be separate entities both termed traders. In this instance, one trader may be the delivery company and the other the company whose goods or services are to be delivered.

The method may allow the verification of delivery confirmed with the orderer, the recipient, the delivery company and the trader whose goods or services were purchased.

The mechanism by which the traders product or service may be ordered may preferably be via the Internet or a national or world wide computer network. The method is equally applicable to any other mechanism of ordering as the present invention is particularly directed towards the verification of receipt of the order, not necessarily to the ordering of the goods or service.

According to a further aspect of the present invention the image may be a digital photograph.

According to a still further aspect of the present invention the image may be a video image.

The image may be transferable to the orderer or may be available on a centralised server, subject to password entry. The Internet or national or international computer network may preferably be the link that allows the users of the method to feel close to the receiver at the time of the delivery.

A hard copy of the images or movies may preferably be supplied to the users of the method. This hard copy may be in the form or a paper form or photograph and may also be in the form of an electronically accessible storage device such as a tape, compact disc or computer disc.

Mobile telephones such as the unit described above may be utilised to receive the delivery confirmation or images as well. There may also be other devices capable of receiving and decoding images transmitted such as personal organisers which may be used.

In this way the image may be transferred without physically handling a computer disc.

### BRIEF DESCRIPTION OF DRAWINGS

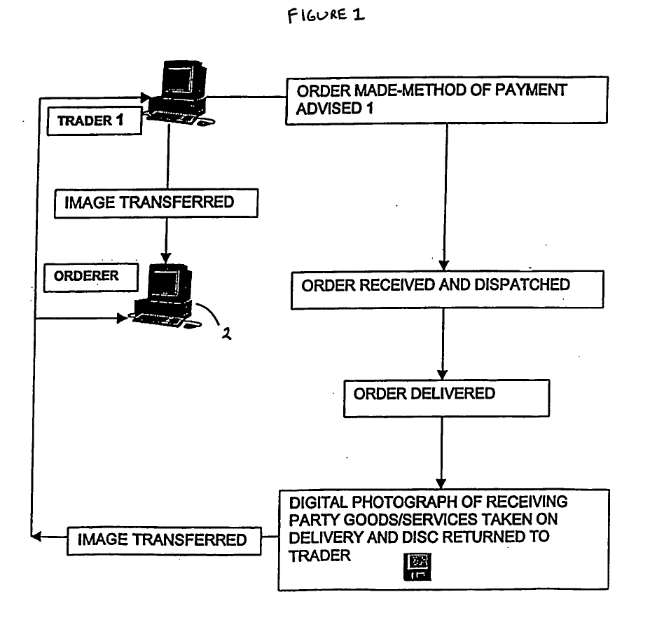

Aspects of the present invention will now be described with reference to the accompanying drawing, FIG. 1 which is a schematic diagram of a method trading according to of the present invention.

With respect to the drawing the present invention provides a method of trading comprising a trader 1 establishing an Internet site from which his product or services can be ordered.

After the trader 1 receives and prepares the order, delivery of the order occurs. Upon delivery of the order, the delivery person takes a digital photograph or movie of the recipient receiving the goods or services. If the delivery is a gift, the delivery person may record a thank-you message or the like. The trader forwards a photographic image from the photograph direct to the orderers computer 2 or to the orderers computer via the trader.

The methodology of the present invention provides by its nature an efficient means of informing persons or organisations of the delivery of goods or services and forms a particularly satisfying method for groups or individuals of delivering and receipting gifts such as presents or flowers to mark occasions both locally and internationally.

The person initiating the order will then have the opportunity of sending the photographic receipt to friends and relatives or others who may have been involved.

Aspects of the present invention have been described by way of example only and it will be appreciated that modifications and additions thereto may be made without departing from the spirit or scope thereof.

1. A method of trading comprising the steps of;
(a) a trader establishing a mechanism by which the traders product or service can be ordered by an orderer,
(b) delivering product or services in response to an order,
(c) taking an image of the product or service delivery and the person receiving the order, and
(d) transmitting a copy of the image to the orderer by way of confirmation of delivery.

2. A method as claimed in claim 1 wherein the mechanism for ordering the traders product or service utilises a national or world wide computer network.

3. A method as claimed in claim 1 wherein the image is a digital photograph.

4. A method as claimed in claim 1 wherein the image is a video image.

5. A method as claimed in claim 1 wherein the image is transferable to the orderer or is available on a centralised server, subject to password entry.

6. A method as claimed in claim 1 wherein an additional hard copy of the images or movies is supplied to the orderer or person receiving the order.

7. A method as claimed in claim 1 wherein a mobile telephone is utilised to receive the image.

8. A method as claimed in claim 1 wherein another device capable of receiving and decoding images transmitted in electronic form is used to receive the image.

9. A method as claimed in claim 1 wherein the copy of the image is transmitted instantaneously to the orderer.

10. A method as claimed in claim 1 wherein the image is transmitted to the trader for loading onto a national or international computer network for access by the orderer.
